(19) United States
(12) Patent Application Publication
(10) Pub. No.: US 2026/0098570 A1
(43) Pub. Date: Apr. 9, 2026

(54) BODY VALVE ASSEMBLY AND SHOCK ABSORBER WITH THE SAME

(71) Applicant: HL Mando Corporation, Pyeongtaek-si (KR)

(72) Inventors: Jeonggil KIM, Pyeongtaek-si (KR); Kwangduk BAEK, Pyeongtaek-si (KR)

(73) Assignee: HL Mando Corporation, Pyeongtaek-si (KR)

(21) Appl. No.: 19/292,705

(22) Filed: Aug. 6, 2025

(30) Foreign Application Priority Data
Oct. 4, 2024 (KR) 10-2024-0134857

(51) Int. Cl. F16F 9/348; B60G 13/08; B60G 17/08; F16F 9/504

(52) U.S. Cl. CPC F16F 9/348; F16F 9/504; B60G 13/08; B60G 17/08; B60G 2202/24; B60G 2204/62; B60G 2206/41; B60G 2500/11; B60G 2600/21; B60G 2800/162; B60G 2800/916; F16F 2222/12; F16F 2224/0208; F16F 2228/04; F16F 2228/066; F16F 2232/08; F16F 2234/02

(57) ABSTRACT

The present disclosure relates to a body valve assembly and a shock absorber including the same. The body valve assembly includes a body valve main body that adjusts a movement of a working fluid between a compression chamber and a reserve chamber, a body pin having a body injection flow channel in communication with the compression chamber formed therein, a body pilot housing having a body pilot chamber in communication with the body injection flow channel formed therein, a free piston coupled to the body pin so as to move axially when a pressure of the body pilot chamber is higher than a preset pressure, and a pilot disc mounted on the body pin while being in contact with the free piston, wherein an end surface of the free piston facing the pilot disc has a plurality of points having different vertical levels.

### CROSS-REFERENCE TO RELATED APPLICATION

This application claims the benefit of and priority to Korean Patent Application No. 10-2024-0134857, filed on Oct. 4, 2024, the entire disclosure(s) of which is hereby incorporated herein by reference in its entirety.

### TECHNICAL FIELD

The present disclosure relates to a body valve assembly and a shock absorber including the same. More specifically, the present disclosure relates to a frequency-sensitive shock absorber capable of simultaneously satisfying riding comfort and adjustment stability by differently controlling a damping force with respect to high frequency and low frequency during a compression stroke or a tensile stroke of a piston valve.

### BACKGROUND

Contents described in this section simply provide background information on the present disclosure and do not constitute the prior art.

In general, a buffering device for improving riding comfort by buffering shock or vibration that an axle receives from a road surface during traveling is installed in a vehicle, and as one of such buffering devices, a shock absorber is used.

The shock absorber is also called a damper and operates based on the vibration of the vehicle depending on a road surface condition. In this regard, a damping force generated from the shock absorber varies depending on an operating speed of the shock absorber, that is, depending on how fast or slow the shock absorber operates.

Because the riding comfort and traveling stability of the vehicle may be controlled based on how characteristics of the damping force generated from the shock absorber are adjusted, it is very important to adjust the damping force characteristics of the shock absorber when designing the vehicle.

For example, the shock absorber includes a cylinder filled with a working fluid such as oil, a piston rod connected to a vehicle body to reciprocate, and a piston valve coupled to a lower end of the piston rod to slide in the cylinder and control a flow of the working fluid.

In one example, a piston valve commonly used in the shock absorber is designed to have constant attenuation characteristics at high speed, medium speed, and low speed using a single flow channel. Therefore, to improve the riding comfort by lowering a low-speed damping force, it may also affect medium-speed and high-speed damping forces.

In addition, an existing shock absorber has a structure in which the damping force changes based on a change in speed of the piston regardless of a frequency or a stroke. As described above, because the damping force, which is changed only based on the change in the speed of the piston, is constant in various road surface conditions, it is difficult to satisfy both the riding comfort and adjustment stability at the same time.

To solve such problems, a body valve assembly capable of generating the damping force that changes based on changes in frequency and the speed, and a frequency-sensitive shock absorber including the same have been proposed (Korean Patent Application Publication No.10-2024-0008777).

However, the proposed body valve assembly and the frequency-sensitive shock absorber including the same still have following limitations.

The body valve assembly may include a free piston that linearly moves in a vertical direction and a disc valve having a fixed central portion. Here, when the free piston linearly moves toward the disc valve and presses an omnidirectional circumference of the disc valve, the disc valve particularly made of metal may be damaged by stress exceeding an elastic limit.

In addition, when a component such as a body spacer or the like in contact with an outer circumferential surface of the free piston is disposed radially inward of the free piston, the working fluid unintentionally flows by a high pressure through a gap between the corresponding component and the free piston, thereby generating a sharp swishing noise.

In addition, in the related art, a fastening position of a nut of a body pin overlaps a position of a body injection flow channel, and there is a problem in that dust generated in a process of fastening the nut of the body pin is introduced into the body injection flow channel, thereby hindering the function of the valve or the flow of the fluid.

### PRIOR ART LITERATURE

### Patent Document

(Patent Document 1) KR 10-2024-0008777 A

### SUMMARY

Accordingly, the present disclosure has been devised to solve the problems of the prior art, and is intended to provide a body valve assembly and a shock absorber including the same capable of generating a damping force that changes based on changes in frequency and speed.

In addition, the present disclosure is intended to provide a body valve assembly and a shock absorber including the same capable of preventing a disc valve from being damaged by a piston that moves linearly.

In addition, the present disclosure is intended to provide a body valve assembly and a shock absorber including the same that prevent noise from being generated as a working fluid passes between a component fastened to a radially inner side of a central axis and a component fastened to a radially outer side thereof.

In addition, the present disclosure is intended to provide a body valve assembly and a shock absorber including the same that do not cause a problem in which dust generated in a process of fastening a nut of a body pin is introduced into a body injection flow channel.

Problems to be solved by the present disclosure are not limited to the above-mentioned problems, and other problems not mentioned will be clearly understood by those skilled in the art from a following description.

A body valve assembly of a shock absorber according to an embodiment of the present disclosure includes a body valve main body that is installed at an end of the shock absorber at a side of a compression chamber and adjusts a movement of a working fluid between the compression chamber and a reserve chamber, a body pin extending through and fastened to the body valve main body and having a body injection flow channel in communication with the compression chamber formed therein, a body pilot housing coupled to the body pin and having a body pilot chamber in communication with the body injection flow channel formed therein, a free piston accommodated in the body pilot housing and coupled to the body pin so as to move axially when a pressure of the body pilot chamber is higher than a preset pressure, and a pilot disc mounted on the body pin while being in contact with the free piston, wherein an end surface of the free piston facing the pilot disc has a plurality of points having different vertical levels.

The free piston may have a protruding portion protruding toward the pilot disc, and the protruding portion may have a different protrusion height based on an angular position thereof.

The protruding portion may have a shape with a ridge having a first height and a valley having a second height sequentially repeated at a specific angular spacing around a central axis.

The protruding portion may have a wave shape with the protrusion height gently changing depending on the angular position.

The body valve assembly may further include a body spacer mounted on the body pin and constructed to maintain a spacing between the pilot disc and the body pilot housing.

The body spacer may be disposed radially inward of the free piston, the free piston may have a concave portion recessed radially outward from an inner circumferential surface of the free piston, and an outer circumferential surface of the body spacer and the concave portion may form a flow channel allowing one side and a remaining side of the free piston to be in communication with each other.

The concave portion may have a semicircular cross-section.

The concave portion of the free piston may include a plurality of concave portions.

The concave portion of the free piston may include four concave portions arranged equiangularly.

The pilot disc may be made of a metal material.

The body pilot housing may have a cylindrical side surface extending axially, and an outer circumferential surface of the free piston may slide in contact with an inner circumferential surface of the side surface of the body pilot housing.

The body valve main body, the body pilot housing, the free piston, and the pilot disc may be sequentially arranged along a first direction.

The body valve assembly may further include a body nut coupled to an end of the body pin in the first direction and constructed to fasten components allowing the body pin to extend therethrough.

An end of the body pin in the first direction may be riveted to prevent deviation of components allowing the body pin to extend therethrough.

An end surface of the body pin in the first direction may be flattened.

The body pin may have a flange formed at an end thereof at a side of the compression chamber.

The body injection flow channel may include a radial flow channel radially formed in the flange.

At least a portion of the body injection flow channel may be in a form of a “U”-shape groove defined in an outer circumferential surface of the body pin.

The radial flow channel may be in a form of a “U”-shaped groove defined in a surface of the flange opposite to the compression chamber.

A shock absorber according to an embodiment of the present disclosure includes a first cylinder partitioned into a compression chamber and a rebound chamber by a piston rod reciprocatable therein and a piston valve mounted on the piston rod, a second cylinder surrounding the first cylinder so as to define a reserve chamber between the first cylinder and the second cylinder, and a body valve assembly that is installed at an end of the first cylinder at a side of the compression chamber and adjusts a movement of a working fluid between the compression chamber and the reserve chamber, wherein the body valve assembly generates a damping force variable depending on a frequency during a compression stroke, wherein the body valve assembly includes a body valve main body that is installed at an end of the shock absorber at a side of the compression chamber and adjusts the movement of the working fluid between the compression chamber and the reserve chamber, a body pin extending through and fastened to the body valve main body and having a body injection flow channel in communication with the compression chamber formed therein, a body pilot housing coupled to the body pin and having a body pilot chamber in communication with the body injection flow channel formed therein, a free piston accommodated in the body pilot housing and coupled to the body pin so as to move axially when a pressure of the body pilot chamber is higher than a preset pressure, and a pilot disc mounted on the body pin while being in contact with the free piston, wherein an end surface of the free piston facing the pilot disc has a plurality of points having different vertical levels.

According to the present disclosure, provided are the body valve assembly and the shock absorber including the same capable of generating the damping force that changes based on the changes in the frequency and the speed.

In addition, provided are the body valve assembly and the shock absorber including the same capable of preventing the disc valve from being damaged by the piston that moves linearly.

In addition, provided are the body valve assembly and the shock absorber including the same capable of preventing the noise from being generated as the working fluid passes between the component fastened to the radially inner side of the central axis and the component fastened to the radially outer side thereof.

In addition, provided are the body valve assembly and the shock absorber including the same capable of not causing the problem in which the dust generated in the process of fastening the nut of the body pin is introduced into the body injection flow channel.

### BRIEF DESCRIPTION OF THE DRAWINGS

FIG. 1 is a cross-sectional view illustrating a body valve assembly according to a first embodiment of the present disclosure and a shock absorber including the same.

FIG. 2 is a plan view illustrating a free piston of a body valve assembly in FIG. 1.

FIG. 3 is a cross-sectional view illustrating a free piston of a body valve assembly in FIG. 1.

FIG. 4 is a top view illustrating an alternative free piston that may be used in a body valve assembly of the present disclosure.

FIG. 5 is a cross-sectional view illustrating an alternative free piston that may be used in a body valve assembly of the present disclosure.

FIG. 6 is a top view illustrating a second alternative free piston that may be used in a body valve assembly of the present disclosure.

FIG. 7 is a cross-sectional view illustrating a second alternative free piston that may be used in a body valve assembly of the present disclosure.

FIG. 8 is a cross-sectional view illustrating a body valve assembly according to a second embodiment of the present disclosure.

### DETAILED DESCRIPTION

Hereinafter, embodiments of the present disclosure will be described in detail with reference to the accompanying drawings such that those skilled in the art to which the present disclosure pertains may easily implement the present disclosure. The present disclosure may be implemented in various different forms and may not be limited to the embodiments described herein.

In addition, in the various embodiments, components having the same configurations will be representatively described in a first embodiment using the same reference numerals, and in other embodiments, only configurations different from those in the first embodiment will be described.

It should be noted that the drawings are schematic and not shown to scale. Relative dimensions and ratios of parts in the drawings are exaggerated or reduced for clarity and convenience in the drawings, and any dimensions are merely exemplary and not restrictive. In addition, the same reference numerals are used to denote similar features in the same structures, elements, or parts shown in two or more drawings.

An embodiment of the present disclosure specifically represents an ideal embodiment of the present disclosure. As a result, various variations of the illustration are expected. Accordingly, the embodiment is not limited to a specific shape of an illustrated area, and includes, for example, a deformation of the shape by manufacturing.

In addition, all technical terms and scientific terms used herein have meanings generally understood by those skilled in the art to which the present disclosure pertains, unless otherwise defined. All terms used herein are selected for the purpose of more clearly describing the present disclosure and are not selected to limit the scope of the present disclosure.

In addition, expressions such as ‘including’, ‘having’, and ‘comprising’ used herein should be understood as open-ended terms that imply a possibility of including other embodiments unless otherwise stated in a phrase or a sentence in which the corresponding expressions are included.

In addition, an expression of a singular form described herein may include a meaning of a plural form unless otherwise stated, and this is also applied to an expression of a singular form described in claims.

In addition, expressions such as “first”, “second”, and the like used herein are used to distinguish a plurality of components from each other, and do not limit an order or an importance of the corresponding components.

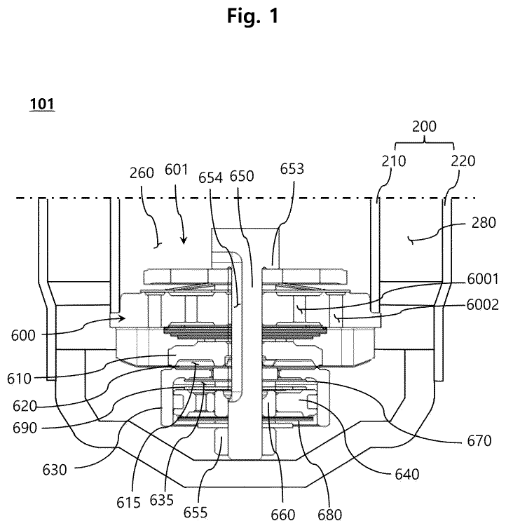

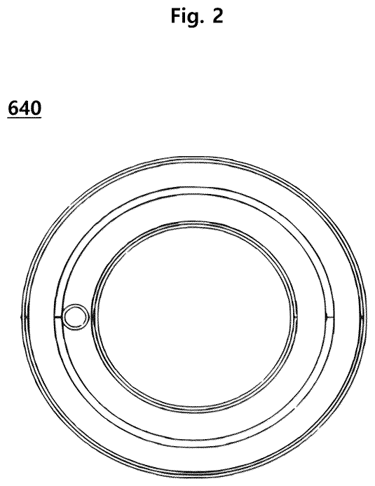

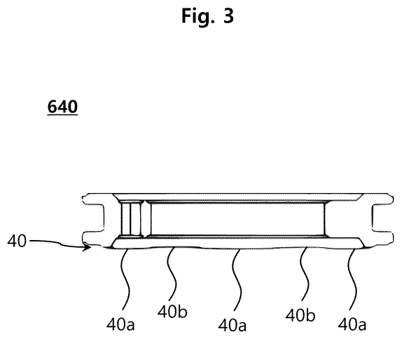

Hereinafter, a body valve assembly 601 according to a first embodiment of the present disclosure and a shock absorber 101 including the same will be described with reference to the drawings. Here, the shock absorber 101 may also be referred to as a damper, and may be installed in a vehicle and be used, for example, to absorb and buffer shock or vibration that an axle receives from a road surface during traveling. FIG. 1 is a cross-sectional view illustrating the body valve assembly 601 according to the first embodiment of the present disclosure and the shock absorber 101 including the same. FIG. 2 is a plan view illustrating a free piston 640 of the body valve assembly 601 in FIG. 1. FIG. 3 is a cross-sectional view illustrating the free piston 640 of the body valve assembly in FIG. 1.

Referring to FIG. 1, the frequency-sensitive shock absorber 101 includes a cylinder 200 and the body valve assembly 601 according to the first embodiment of the present disclosure.

In addition, although not shown in FIG. 1, the frequency-sensitive shock absorber 101 may further include a piston rod and a piston valve main body.

The cylinder 200 may have a cylindrical shape defining a space therein, and a working fluid is filled inside the cylinder 200. Further, the cylinder 200 may include a first cylinder 210 and a second cylinder 220.

A piston valve main body 300 to be described later may be disposed inside the first cylinder 210 so as to be ascendable and descendable, and the inside of the first cylinder 210 may be divided into a compression chamber 260 and a rebound chamber (not shown) by the piston valve main body 300. For example, based on the piston valve main body 300, an upper portion of the first cylinder 210 may be the rebound chamber, and a lower portion of the first cylinder 210 may be the compression chamber 260.

The second cylinder 220 may surround the first cylinder 210 with a separation space defined therebetween, and may define a reserve chamber 280 between the first cylinder 210 and the second cylinder 220.

The piston rod may reciprocate in the first cylinder 210. In addition, the piston valve main body to be described later is mounted at one side of the piston rod.

The piston valve main body may divide the inside of the first cylinder 210 into the compression chamber 260 and the rebound chamber (not shown).

The body valve assembly 601 is installed at an end of the first cylinder 210 at a side of the compression chamber 260 and adjusts a movement of the working fluid between the compression chamber 260 and the reserve chamber 280. In particular, in the first embodiment of the present disclosure, the body valve assembly 601 generates a damping force that varies based on a magnitude of a frequency during a compression stroke.

Specifically, the body valve assembly 601 includes a body valve main body 600, a body pin 650, a body pilot housing 630, the free piston 640, and a pilot disc 680.

In addition, the body valve assembly 601 may further include one or more of a body main retainer 610, a body main valve 620, a body inlet disc 690, a body nut 655, a disc spring 670, and a body spacer 660.

The body valve main body 600 is installed at the end at the side of the compression chamber 260 to adjust the movement of the working fluid between the compression chamber 260 and the reserve chamber 280. That is, the body valve main body 600 may include a plurality of body compression flow channels 6001 and a plurality of body tension flow channels 6002 formed to extend therethrough in a direction of connecting the compression chamber 260 with the reserve chamber 280 such that the fluid may move between the compression chamber 260 and the reserve chamber 280.

Accordingly, during the compression stroke, the fluid inside the compression chamber 260 may generate a damping force against the shock or the vibration while moving to the rebound chamber via the piston valve main body 300 or moving to the reserve chamber 280 via the body valve main body 600.

The body pin 650 is fastened through the body valve main body 600, and a body injection flow channel 654 in communication with the compression chamber 260 is formed. Here, at least a portion of the body injection flow channel 654 may be in a form of a “U”-shaped groove defined in an outer circumferential surface of the body pin 650. The body pin 650 may have a flange 653 formed at an end at a side of the compression chamber 260. The body injection flow channel 654 may include a radial flow channel formed in the flange 653 in a radial direction. The radial flow channel may be in a form of a “U”-shaped groove defined in a surface of the flange opposite to the compression chamber 260.

The body main retainer 610 is coupled to the body pin 650. For example, the body main retainer 610 may be coupled to the body pin 650 so as to be disposed adjacent to the other surface opposite to one surface of the body valve main body 600 facing the compression chamber 260. Further, the body main retainer 610 has a body main chamber 615 formed to be in communication with the body injection flow channel 654 formed in the body pin 650.

Specifically, one side of the body main retainer 610 may face the body valve main body 600, and the body main chamber 615 may be formed at the other side of the body main retainer 610. That is, the body main retainer 610 may have a portion of the other side facing a body pilot housing 630, which will be described later, opened, and the body main chamber 615 may be formed in such an opened portion.

The body main valve 620 is coupled to the body pin 650 to open and close the body main chamber 615. That is, the body main valve 620 may open and close the body main chamber 615 while being in contact with or separated from the other side of the body main retainer 610.

The body pilot housing 630 is coupled to the body pin 650, and the body pilot chamber 635 in communication with the body injection flow channel 654 is formed therein. The body pilot chamber 635 in which one side of the body pilot housing 630 faces the body main valve 620 and the other side thereof is in communication with the body injection flow channel 654 may be formed. That is, a portion of the other side of the body pilot housing 630 facing the free piston 640 to be described later may be opened, and the body pilot chamber 635 may be formed in the opened portion. In addition, one side of the body pilot housing 630 facing the body main valve 620 may press the body main valve 620 to allow the body main valve 620 to close the body main chamber 615 based on an operation of the free piston 640 to be described later. The body pilot housing 630 may have a cylindrical side surface extending in an axial direction.

The body inlet disc 690 may be interposed between the body pilot housing 630 and the free piston 640 and allow the body pilot chamber 635 to be in communication with the body injection flow channel 654.

The body inlet disc 690 may include at least one body inlet disc slit 693 defined to allow the body injection flow channel 654 formed in the body pin 650 to be in communication with the body pilot chamber 635 such that the working fluid is introduced into the body pilot chamber 635. Such a body inlet disc slit 693 may be defined from a hollow of the body inlet disc 690 through which the body pin 650 extends to a position in communication with the body pilot chamber 635. Accordingly, the body injection flow channel 654 and the body pilot chamber 635 may be in communication with each other via the body inlet disc slit 693. In addition, a flow rate of the working fluid introduced into the body pilot chamber 635 may be adjusted by adjusting the number and size of the body inlet disc slits 693.

As described above, because the body pilot chamber 635 is in communication with the body injection flow channel 654 via the body inlet disc 690, an inflow rate of the working fluid into the body pilot chamber 635 during the compression stroke may be relatively limited compared to an inflow rate of the working fluid into the body main chamber 615, depending on the frequency.

For example, as a pressure of the working fluid introduced into the body injection flow channel 654 increases, the inflow rate of the working fluid into the body pilot chamber 635 decreases compared to the inflow rate of the working fluid into the body main chamber 615.

The free piston 640 is accommodated in the body pilot housing 630 and is coupled to the body pin 650 to move in the axial direction when a pressure in the body pilot chamber 635 is higher than a predetermined pressure. An outer circumferential surface of the free piston 640 may slide while being in contact with an inner circumferential surface of a side surface of the body pilot housing 630. Specifically, the free piston 640 may be installed to press the body pilot housing 630 toward the body main valve 620 when the pressure in the body pilot chamber 635 is higher than the preset pressure. Here, the predetermined pressure may be variously set based on a performance required for the frequency-sensitive shock absorber 101, and may be a pressure at which the pressure of the body main chamber 615 and the pressure of the body pilot chamber 635 are balanced. Further, the predetermined pressure may be adjusted by the size of at least one body inlet disc slit 693 defined in the body inlet disc 690, a disc spring 670 to be described later, and the like.

Referring to FIGS. 1 to 3, an end surface of the free piston 640 facing the pilot disc 680 has a plurality of points having different vertical levels. When the pressure in the body pilot chamber 635 increases and the free piston 640 presses the pilot disc 680, only a portion of the end surface of the free piston 640 facing the pilot disc 680 that protrudes most toward the pilot disc 680 presses the pilot disc 680. Accordingly, the free piston 640 according to the present disclosure presses only a portion of a circumference of the pilot disc 680 (without pressing the circumference omnidirectionally), so that the pilot disc 680 rotates instead of being deformed, thereby preventing the pilot disc 680 from being damaged. A through-hole lifted by the body pin 650 and the body spacer 660 may be defined in a central portion of the free piston 640.

In the present disclosure, an angular position refers to an angular position on a virtual polar coordinate system with a stroke axis of the piston rod as a normal line. The free piston 640 may have a protruding portion 40 protruding toward the pilot disc 680, and the protruding portion 40 may have a different protrusion height depending on the angular position. The protruding portion 40 may have a shape in which a ridge 40a having a first height and a valley 40b having a second height are sequentially repeated at a specific angular spacing around a central axis (the stroke axis of the piston). As illustrated in FIGS. 1 to 3, the protruding portion 40 may have a wave shape in which the protrusion height thereof gently changes based on the angular position.

The free piston 640 may operate to press the body pilot housing 630 toward the body main valve 620 by a pressure of the working fluid introduced into the body pilot chamber 635 during a low frequency compression stroke so that the body main valve 620 closes the body main chamber 615. In addition, the free piston 640 operates such that the body main valve 620 is opened by the pressure of the body main chamber 615 because the force of pressing the body pilot housing 630 toward the body main valve 620 is weakened as the pressure of the working fluid introduced into the body pilot chamber 635 becomes relatively lower than a pressure of the working fluid introduced into the body main chamber 615 during a high frequency compression stroke.

Here, the reason why the pressure of the working fluid introduced into the body pilot chamber 635 becomes relatively lower than the pressure of the working fluid introduced into the body main chamber 615 during the high frequency compression stroke is that the inflow rate of the working fluid into the body pilot chamber 635 is limited via the body inlet disc 690.

For example, during the low frequency compression stroke, the flow rate of the working fluid introduced into the body pilot chamber 635 via the body inlet disc 690 is sufficient, so that the pressure of the body pilot chamber 635 is smoothly formed, and thus, when the pressures of the body pilot chamber 635 and the body main chamber 615 are balanced, the body main valve 620 is not opened. However, during the high frequency compression stroke, the flow rate of the working fluid introduced into the body pilot chamber 635 is limited by the body inlet disc 690, and the pressure of the body pilot chamber 635 becomes lower than the pressure of the body main chamber 615. Therefore, as the force of the free piston 640 pressing the body pilot housing 630 toward the body main valve 620 is weakened, the body main valve 620 is opened by the pressure of the body main chamber 615, thereby allowing the working fluid of the compression chamber 260 to move to the reserve chamber 280 via the body injection flow channel 654 and the body main chamber 615.

That is, the working fluid of the compression chamber 260 moves to the reserve chamber 280 via the body valve main body 600 during the low frequency compression stroke, whereas the working fluid of the compression chamber 260 moves to the reserve chamber 280 via the body valve main body 600, the body injection flow channel 654, and the body main chamber 615 during the high frequency compression stroke. Therefore, the frequency-sensitive shock absorber 101 may vary the generated damping force based on a change in the frequency.

The disc spring 670 may elastically press the body pilot housing 630 toward the body main valve 620. That is, in a state in which no pressure is applied to the body pilot chamber 635, the body pilot housing 630 is in contact with the body main valve 620 by the disc spring 670, and the body main valve 620 is in contact with the body main retainer 610 to maintain a state of closing the body main chamber 615. Such a disc spring 670 may be used to adjust the damping force of the frequency-sensitive shock absorber 101, and may also affect the pressure balance between the body main chamber 615 and the body pilot chamber 635.

The pilot disc 680 is mounted on the body pin 650 while being in contact with the free piston 640. The free piston 640 may be mounted on the body pin 650 at the other side thereof opposite to one side facing the body pilot housing 630. The pilot disc 680 may be made of a metal material.

The body spacer 660 may be mounted on the body pin 650 to maintain a minimum spacing between the body washer 680 and the body pilot housing 630. The body spacer may be disposed radially inward of the free piston 640.

The body valve main body 600, the body pilot housing 630, the free piston 640, and the pilot disc 680 may be sequentially arranged along a first direction (a downward direction in FIG. 1). Here, the components being sequentially arranged refers to a relative arrangement between the listed components, and components that are not listed may be additionally arranged between the components. The body nut 655 may be coupled to an end of the body pin 650 in the first direction to fasten components through which the body pin 650 extends with each other. That is, the body nut 655 may prevent not only the body valve main body 600 but also the body main retainer 610, the body pilot housing 630, the free piston 640, and the like from being deviated from the body pin 650. The body nut of the existing body valve assembly was coupled to an end of the body pin at a side of the body valve main body, that is, an end at a side of the compression chamber 260. Because the body injection flow channel is formed at the end of the body pin at the side of the compression chamber, in the existing body valve assembly, there was a problem in that metal dust generated when the body nut is fastened to the body pin at the side of the compression chamber is introduced into the body injection flow channel and causes a problem in the fluid flow adjustment. Because the body pin 650 of the body valve assembly 601 according to the first embodiment of the present disclosure is fastened by the body nut 655 coupled thereto at a side opposite to the body injection flow channel 654, there is no risk that dust generated during the fastening may cause the problem in the fluid flow adjustment.

With the above-described configuration, the body valve assembly 601 according to the first embodiment of the present disclosure and the frequency-sensitive shock absorber 101 including the same may generate the damping force that effectively changes based on changes in the frequency and a speed.

With the above-described configuration, the body valve assembly 601 according to the first embodiment of the present disclosure and the frequency-sensitive shock absorber 101 including the same may generate the damping force that effectively changes based on changes in the frequency and a speed.

Specifically, by adjusting the flow rates of the working fluid that has passed through the body injection flow channel 654 introduced into the body pilot chamber 635 and the body main chamber 615 during the compression stroke, a similar damping force may be realized at a low frequency and a high frequency in a low speed period, and the damping force may be varied depending on the low frequency and the high frequency in medium and high speed periods, thereby simultaneously satisfying the riding comfort and adjustment stability of the vehicle.

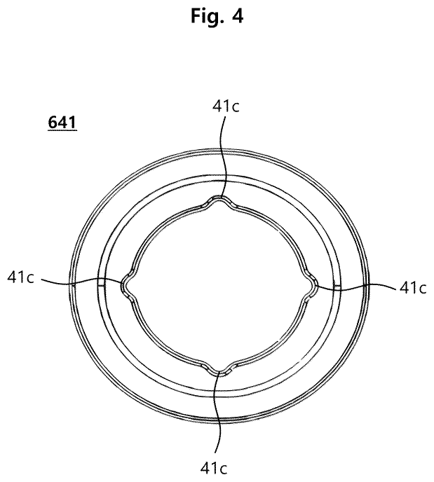

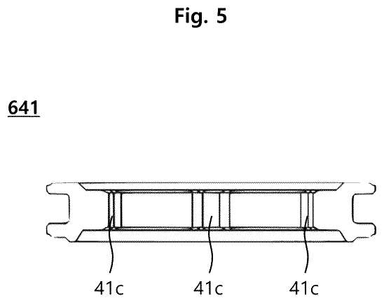

Hereinafter, an alternative free piston 641 that may be used in the body valve assembly according to the first embodiment of the present disclosure will be described. It is to be understood that the alternative free piston 641 may also be used in another embodiment of the present disclosure. FIG. 4 is a top view illustrating the alternative free piston 641 that may be used in the body valve assembly of the present disclosure. FIG. 5 is a cross-sectional view illustrating the alternative free piston 641 that may be used in the body valve assembly of the present disclosure.

The body spacer 660 (see FIG. 1) may be disposed radially inward of the free piston 641, and the free piston 641 may have a concave portion 41c recessed radially outward from an inner circumferential surface of the free piston 641. The outer circumferential surface of the body spacer 660 and the concave portion 41c may form a ‘flow channel that allows one side and the other side of the free piston 641 to be in communication with each other’. By forming the flow channel between the free piston 641 and the body spacer 660 as described above, the sharp swishing noise generated when the fluid unintentionally flows through a narrow gap between the free piston 641 and the body spacer 660 may be prevented.

The free piston 641 may have a plurality of concave portions 41c. The free piston 641 may have four concave portions 41c, and the concave portions 41c may be arranged equiangularly.

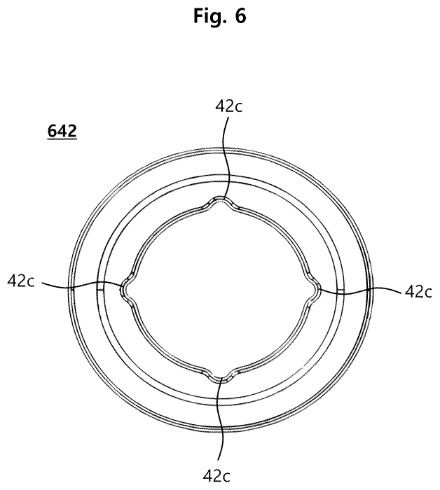

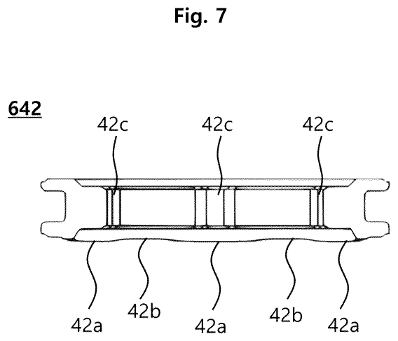

Hereinafter, a second alternative free piston 642 that may be used in the body valve assembly according to the first embodiment of the present disclosure will be described. It is to be understood that the second alternative free piston 642 may also be used in another embodiment of the present disclosure. FIG. 6 is a top view illustrating the second alternative free piston 642 that may be used in the body valve assembly of the present disclosure. FIG. 7 is a cross-sectional view illustrating the second alternative free piston 642 that may be used in the body valve assembly of the present disclosure.

An end surface of the free piston 642 facing the pilot disc 680 (see FIG. 1) has a plurality of points having different vertical levels. When the pressure in the body pilot chamber 635 increases and the free piston 642 presses the pilot disc 680, only a portion of the end surface of the free piston 642 facing the pilot disc 680 that protrudes most toward the pilot disc 680 presses the pilot disc 680. Accordingly, the free piston 642 presses only the portion of the circumference of the pilot disc 680 (without pressing the circumference omnidirectionally), so that the pilot disc 680 rotates instead of being deformed, thereby preventing the pilot disc 680 from being damaged. A through-hole lifted by the body pin 650 (see FIG. 1) and the body spacer 660 (see FIG. 1) may be defined in a central portion of the free piston 642.

In the present disclosure, the angular position refers to the angular position on the virtual polar coordinate system with the stroke axis of the piston rod as the normal line. The free piston 642 may have a protruding portion 42 protruding toward the pilot disc 680, and the protruding portion 42 may have a different protrusion height depending on the angular position. The protruding portion 42 may have a shape in which a ridge 42a having a first height and a valley 42b having a second height are sequentially repeated at a specific angular spacing around a central axis (the stroke axis of the piston). As illustrated in FIGS. 6 and 7, the protruding portion 42 may have a wave shape in which the protrusion height thereof gently changes based on the angular position.

The body spacer 660 may be disposed radially inward of the free piston 642, and the free piston 642 may have a concave portion 42c recessed radially outward from an inner circumferential surface of the free piston 642. The outer circumferential surface of the body spacer 660 and the concave portion 42c may form a ‘flow channel that allows one side and the other side of the free piston 642 to be in communication with each other’. By forming the flow channel between the free piston 642 and the body spacer 660 as described above, the sharp swishing noise generated when the fluid unintentionally flows through a narrow gap between the free piston 642 and the body spacer 660 may be prevented.

The free piston 642 may have a plurality of concave portions 42c. The free piston 642 may have four concave portions 42c, and the concave portions 42c may be arranged equiangularly.

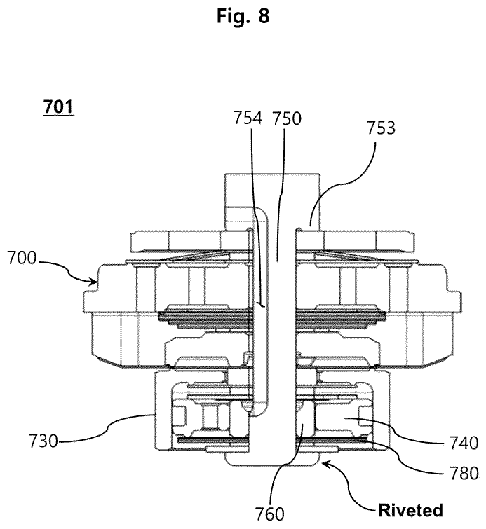

Hereinafter, a body valve assembly according to a second embodiment of the present disclosure will be described. In describing the second embodiment, a part substantially redundant with the description or the illustration of the first embodiment is omitted. In addition, among components of the second embodiments, those substantially the same as the components of the first embodiment are referred to by the same names as the corresponding components of the first embodiment. FIG. 8 is a cross-sectional view illustrating a body valve assembly 701 according to a second embodiment of the present disclosure.

Referring to FIG. 8, the body valve assembly according to the second embodiment of the present disclosure includes a body valve main body 700, a body pin 750, a body pilot housing 730, a free piston 740, a pilot disc 780, and a body spacer 760.

The body pin 750 is fastened through the body valve main body 700, and a body injection flow channel 754 in communication with the compression chamber 260 (see FIG. 1) is formed in the body pin 750. Here, at least a portion of the body injection flow channel 754 may be in a form of a “U”-shaped groove defined in an outer circumferential surface of the body pin 750. The body pin 750 may have a flange 753 formed at an end thereof at a side of the compression chamber 260. The body injection flow channel 754 may include a radial flow channel formed in the flange 753 in the radial direction. The radial flow channel may be in a form of a “U”-shaped groove defined in a surface of the flange opposite to the compression chamber 260.

The body valve main body 700, the body pilot housing 730, the free piston 740, and the pilot disc 780 may be sequentially arranged along the first direction (the downward direction in FIG. 1). Here, the components being sequentially arranged refers to a relative arrangement between the listed components, and components that are not listed may be additionally arranged between the components. In the body valve assembly 701 according to the second embodiment, an end in the first direction of the body pin 750 is riveted to prevent components through which the body pin 750 extends from being deviated. Because the body injection flow channel 754 is formed at the end of the body pin 750 at the side of the compression chamber 260, in the existing body valve assembly, there was a problem in that the metal dust generated when the body nut is fastened to the body pin at the side of the compression chamber is introduced into the body injection flow channel and causes the problem in the fluid flow adjustment. Because the body pin 750 of the body valve assembly 701 according to the second embodiment of the present disclosure fixes the components via the riveting at a side opposite to the compression chamber 260, the dust generated when the nut is fastened does not cause the problem in the fluid flow adjustment. An end surface of the body pin 750 in the first direction may be processed flat.

The above description is merely illustrative of the technical idea of the present disclosure, and various modifications, changes, and substitutions are able to be made by those skilled in the art to which the present disclosure pertains without departing from the essential characteristics of the present disclosure. Therefore, the present embodiment is not for limiting the technical idea of the present disclosure, but for describing the present disclosure, and the scope of the technical idea of the present disclosure is not limited by the above embodiments. The scope of protection of the present disclosure should be interpreted by the following claims, and all technical ideas within the equivalent scope should be interpreted as being included in the scope of the present disclosure.

### DETAILED DESCRIPTION OF MAIN ELEMENTS

101: shock absorber.
600, 700: body valve main body
601, 701: body valve assembly
630, 730: body pilot housing
640, 641, 642, 740: free piston
650, 750: body pin
653, 753: flange
654, 754: body injection flow channel
655: body nut
660, 760: body spacer
680, 780: pilot disc

What is claimed is:

1. A body valve assembly of a shock absorber, the body valve assembly comprising:
a body valve main body installed at an end of the shock absorber at a side of a compression chamber and configured to adjust a movement of a working fluid between the compression chamber and a reserve chamber;
a body pin extending through and fastened to the body valve main body and having a body injection flow channel in communication with the compression chamber formed therein;
a body pilot housing coupled to the body pin and having a body pilot chamber in communication with the body injection flow channel formed therein;
a free piston accommodated in the body pilot housing and coupled to the body pin so as to move axially when a pressure of the body pilot chamber is higher than a preset pressure; and
a pilot disc mounted on the body pin while being in contact with the free piston,
wherein an end surface of the free piston facing the pilot disc has a plurality of points having different vertical levels.

2. The body valve assembly of claim 1, wherein the free piston has a protruding portion protruding toward the pilot disc,
wherein the protruding portion has a different protrusion height based on an angular position thereof.

3. The body valve assembly of claim 2, wherein the protruding portion has a shape with a ridge having a first height and a valley having a second height sequentially repeated at a specific angular spacing around a central axis.

4. The body valve assembly of claim 3, wherein the protruding portion has a wave shape with the protrusion height gently changing depending on the angular position.

5. The body valve assembly of claim 1, further comprising a body spacer mounted on the body pin and constructed to maintain a spacing between the pilot disc and the body pilot housing.

6. The body valve assembly of claim 5, wherein the body spacer is disposed radially inward of the free piston,
wherein the free piston has a concave portion recessed radially outward from an inner circumferential surface of the free piston,
wherein an outer circumferential surface of the body spacer and the concave portion form a flow channel allowing one side and a remaining side of the free piston to be in communication with each other.

7. The body valve assembly of claim 6, wherein the concave portion has a semicircular cross-section.

8. The body valve assembly of claim 7, wherein the concave portion of the free piston includes a plurality of concave portions.

9. The body valve assembly of claim 8, wherein the concave portion of the free piston includes four concave portions arranged equiangularly.

10. The body valve assembly of claim 1, wherein the pilot disc is made of a metal material.

11. The body valve assembly of claim 1, wherein the body pilot housing has a cylindrical side surface extending axially,
wherein an outer circumferential surface of the free piston slides in contact with an inner circumferential surface of the side surface of the body pilot housing.

12. The body valve assembly of claim 1, wherein the body valve main body, the body pilot housing, the free piston, and the pilot disc are sequentially arranged along a first direction.

13. The body valve assembly of claim 12, further comprising a body nut coupled to an end of the body pin in the first direction and constructed to fasten components allowing the body pin to extend therethrough.

14. The body valve assembly of claim 12, wherein an end of the body pin in the first direction is riveted to prevent deviation of components allowing the body pin to extend therethrough.

15. The body valve assembly of claim 14, wherein an end surface of the body pin in the first direction is flattened.

16. The body valve assembly of claim 12, wherein the body pin has a flange formed at an end thereof at a side of the compression chamber.

17. The body valve assembly of claim 16, wherein the body injection flow channel includes a radial flow channel radially formed in the flange.

18. The body valve assembly of claim 17, wherein at least a portion of the body injection flow channel is in a form of a “U”-shape groove defined in an outer circumferential surface of the body pin.

19. The body valve assembly of claim 18, wherein the radial flow channel is in a form of a “U”-shaped groove defined in a surface of the flange opposite to the compression chamber.

20. A shock absorber comprising:
a first cylinder partitioned into a compression chamber and a rebound chamber by a piston rod reciprocatable therein and a piston valve mounted on the piston rod;
a second cylinder surrounding the first cylinder so as to define a reserve chamber between the first cylinder and the second cylinder; and
a body valve assembly installed at an end of the first cylinder at a side of the compression chamber and configured to adjust a movement of a working fluid between the compression chamber and the reserve chamber, wherein the body valve assembly is configured to generate a damping force variable depending on a frequency during a compression stroke,
wherein the body valve assembly includes:
a body valve main body installed at an end of the shock absorber at a side of the compression chamber and configured to adjust the movement of the working fluid between the compression chamber and the reserve chamber;
a body pin extending through and fastened to the body valve main body and having a body injection flow channel in communication with the compression chamber formed therein;
a body pilot housing coupled to the body pin and having a body pilot chamber in communication with the body injection flow channel formed therein;
a free piston accommodated in the body pilot housing and coupled to the body pin so as to move axially when a pressure of the body pilot chamber is higher than a preset pressure; and
a pilot disc mounted on the body pin while being in contact with the free piston, wherein an end surface of the free piston facing the pilot disc has a plurality of points having different vertical levels.
